(19) United States
(12) Patent Application Publication
(10) Pub. No.: US 2026/0074415 A1
(43) Pub. Date: Mar. 12, 2026

(54) SMART GLASSES

(71) Applicant: GOERTEK INC., Weifang (CN)

(72) Inventors: Bin JIANG, Weifang (CN); Yaocheng LIU, Weifang (CN); Peng GAO, Weifang (CN); Pan WANG, Weifang (CN); Xiaochao SONG, Weifang (CN); Xiangdong LAN, Weifang (CN); Ziheng DING, Weifang (CN); Hongyuan ZHANG, Weifang (CN); Qingkao WU, Weifang (CN)

(21) Appl. No.: 19/389,327

(22) Filed: Nov. 14, 2025

Related U.S. Application Data
(63) Continuation of application No. PCT/CN2024/136674, filed on Dec. 4, 2024.

(30) Foreign Application Priority Data
Mar. 29, 2024 (CN) 202420627892.7

(51) Int. Cl. H01Q 1/27; G02B 27/01; H01Q 1/52

(52) U.S. Cl. CPC H01Q 1/273; G02B 27/0176; H01Q 1/526; G02B 2027/0178

(57) ABSTRACT

The present application provides smart glasses. The smart glasses include a support member, an imaging device and an antenna mounted on the support member; the antenna includes an antenna body and a coaxial line electrically connected to the antenna body; the coaxial line is provided with a shielding layer; the support member has electrical conductivity, and the coaxial line is fixed to the support member; the shielding layer is electrically connected to the support member so as to realize grounding of the antenna.

### CROSS-REFERENCE TO RELATED APPLICATIONS

The present application is a continuation application of International Application No. PCT/CN2024/136674, filed on Dec. 4, 2024, which claims priority to Chinese Patent Application No. 202420627892.7, entitled in “SMART GLASSES” and filed on Mar. 29, 2024. The disclosures of the above-mentioned applications are incorporated herein by reference in their entireties.

### TECHNICAL FIELD

The present application relates to the technical field of smart glasses, and in particular to smart glasses.

### BACKGROUND

With the continuous development of technology, smart glasses have now been deeply integrated with augmented reality (AR) technology. The resulting AR smart glasses combine processors, displays, sensors, and input devices to provide an AR platform in the form of a vehicle. Through the physical carrier of the glasses, the display screen is brought close to the user's eyes. These products are generally used for a long time, and the hardware design requires strict control over the size and weight of the smart glasses, leaving very limited space for antennas.

### SUMMARY

The main purpose of the present application is to provide a kind of smart glasses, aiming to reduce the space occupied by the antenna.

To achieve the above-mentioned purpose, the smart glasses proposed in the present application include:

a support member;

an imaging device mounted on the support member; and

an antenna including an antenna body and a coaxial line electrically connected to the antenna body; the coaxial line is provided with a shielding layer;

the support member is conductive, and the coaxial line is fixed to the support member; the shielding layer is electrically connected to the support member to achieve grounding of the antenna.

In an embodiment, the coaxial line is further provided with an outer insulating layer covering the shielding layer, and the coaxial line is peeled to have a plurality of grounding positions spaced apart along a length direction of the coaxial line; the grounding positions expose the shielding layer for electrical connection with the support member.

In an embodiment, a protective layer is provided on an outer surface of the support member, and the support member is provided with an electrical connection position corresponding to each of the grounding positions; the protective layer is removed at the electrical connection position to electrically connect to the shielding layer corresponding to the grounding position.

In an embodiment, the electrical connection position is configured as a laser engraved position or a polished position.

In an embodiment, the electrical connection position and the grounding position are electrically connected via a conductive adhesive.

In an embodiment, the imaging device includes an optical engine and a waveguide plate; the support member includes a first support portion for mounting the waveguide plate, and a second support portion for mounting the optical engine, and the first support portion and the second support portion are both provided with the electrical connection position.

In an embodiment, the outer insulating layer of the coaxial line is bonded and fixed to the support member.

In an embodiment, the coaxial line is provided with a plurality of bonding positions spaced apart along the length direction of the coaxial line, and the plurality of bonding positions and the plurality of grounding positions are alternately arranged in sequence.

In an embodiment, the support member is a frame of the smart glasses or an independent component located within the frame.

In an embodiment, the imaging device includes two waveguide plates, and the support member includes two first support portions for mounting the two waveguide plates respectively; each of the waveguide plates is provided with the antenna, and the coaxial lines of the two antennas extend to an upper side of the same first support portion and are fixed and electrically connected to the first support portion.

The above-mentioned smart glasses have at least the following beneficial effects:

The technical solution of the present application adopts a support member, an imaging device and an antenna, which is installed on the support member; the antenna includes an antenna body and a coaxial line electrically connected to the antenna body, and the coaxial line has a shielding layer; the support member is conductive; the coaxial line is fixed to the support member, and the shielding layer is electrically connected to the support member to achieve antenna grounding. It can be understood that smart glasses such as AR glasses require built-in antennas to receive Wifi and Bluetooth signals, among which coaxial line feeding is a common feeding method for antennas. However, the electrical length of a longer coaxial line is comparable to the working wavelength of the antenna, and the shielding layer of the coaxial line has a strong surface current distribution, which affects the impedance matching and consistency of the antenna. This solution electrically connects the shielding layer of the coaxial line to a conductive support member, so that the support member not only has its own supporting effect, but also can improve the surface current distribution of the shielding layer of the coaxial line, thereby improving the influence of the surface current on the impedance matching and consistency of the antenna, and improving the antenna performance; therefore, this solution can save the additional grounding structure of the antenna, thereby reducing the space occupied by the antenna, improving the space utilization of smart glasses, and thus improving the compactness of smart glasses.

### BRIEF DESCRIPTION OF THE DRAWINGS

In order to more clearly illustrate the embodiments of the present application or the technical solutions in the related art, the following briefly introduces the drawings required for use in the embodiments or the description of the related art. Obviously, the drawings described below are only some embodiments of the present application. For those skilled in the art, other drawings can be obtained based on the structures shown in these drawings without paying any creative work.

FIG. 1 is a schematic structural diagram of smart glasses according to an embodiment of the present application.

FIG. 2 is a schematic structural diagram of an electrical connection position of an antenna of the smart glasses of the present application.

FIG. 3 is a partial enlarged diagram of point A in FIG. 2.

The purpose, functional features and advantages of the present application will be further explained in conjunction with the embodiments and with reference to the accompanying drawings.

### DETAILED DESCRIPTION OF THE EMBODIMENTS

The following will be combined with the drawings in the embodiments of the present application to clearly and completely describe the technical solutions in the embodiments of the present application. Obviously, the embodiments described are only part of the embodiments of the present application, not all of the embodiments. Based on the embodiments of the present application, all other embodiments obtained by those skilled in the art without making creative efforts are within the protection scope of the present application.

It should be noted that all directional indications (such as up, down, left, right, front, back, etc.) in the embodiments of the present application are only used to explain the relative position relationship, movement status, etc. between the various components under a certain specific posture (as shown in the accompanying drawings). If the specific posture changes, the directional indication will also change accordingly.

In the present application, unless otherwise specified or limited, the terms “connection” and “fixation” should be understood in a broad sense. For example, “fixation” can mean fixed connection, detachable connection, or integration; mechanical connection or electrical connection; direct connection or indirect connection through an intermediate medium; internal communication between two elements or interaction between two elements, unless otherwise specified. For those skilled in the art, the specific meanings of the above terms in th e present application can be understood according to specific circumstances.

In addition, if there are descriptions involving “first”, “second”, etc. in the embodiments of the present application, the descriptions of “first”, “second”, etc. are only for descriptive purposes and cannot be understood as indicating or suggesting their relative importance or implicitly indicating the number of the indicated technical features. Therefore, the features defined as “first” and “second” may explicitly or implicitly include at least one of such features. In addition, the meaning of “and/or” appearing throughout the text includes three parallel schemes. Taking “A and/or B” as an example, it includes scheme A, or scheme B, or a scheme in which A and B are satisfied at the same time. In addition, the technical solutions between the various embodiments can be combined with each other, but it must be based on the ability of those skilled in the art to implement. When the combination of technical solutions is mutually contradictory or cannot be implemented, it should be deemed that such a combination of technical solutions does not exist and is not within the protection scope required by the present application.

The present application provides a pair of smart glasses.

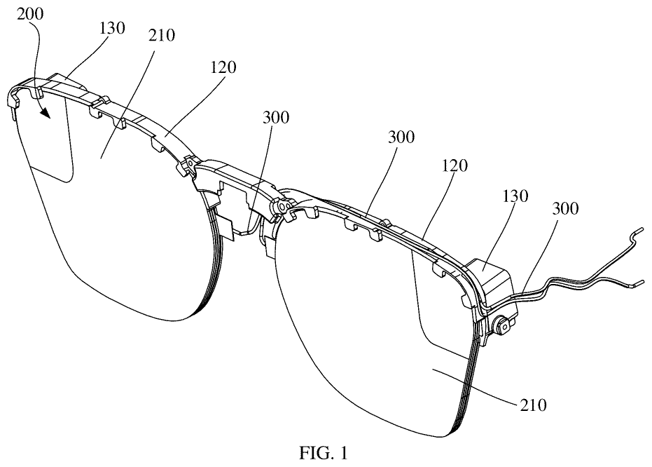

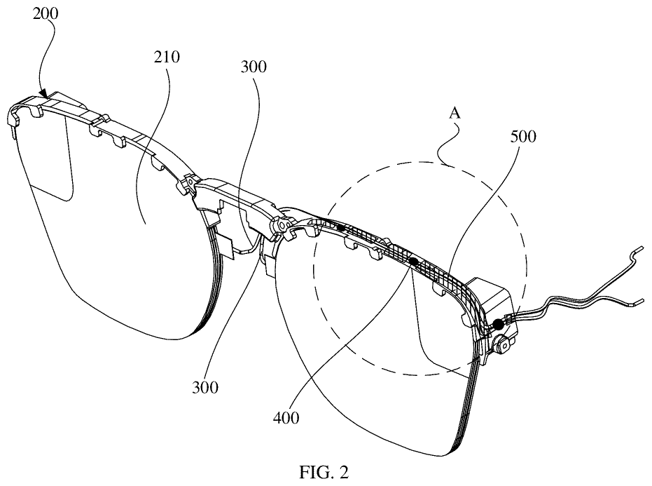

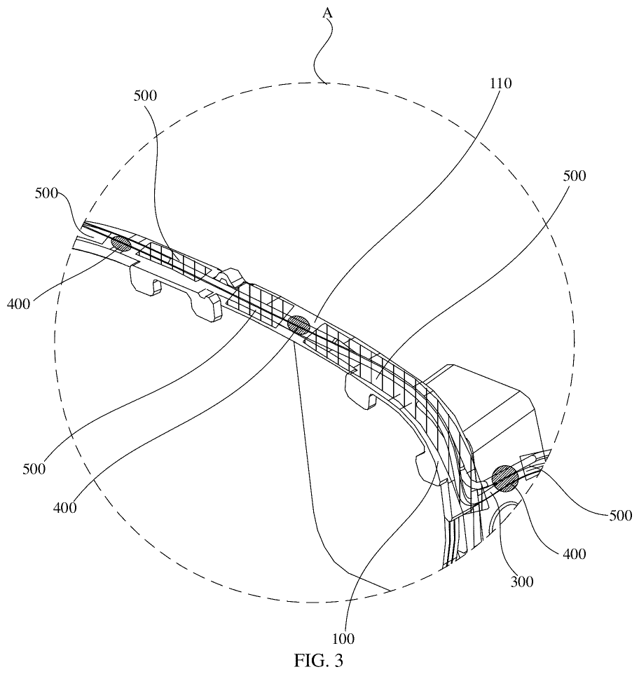

Referring to FIGS. 1 to 3, in an embodiment of the present application, the smart glasses include a support member 100, an imaging device 200, and an antenna, which is mounted on the support member 100; the antenna includes an antenna body, and a coaxial line 300 electrically connected to the antenna body, the coaxial line 300 having a shielding layer; the support member 100 is conductive; the coaxial line 300 is fixed to the support member 100, and the shielding layer is electrically connected to the support member 100 to achieve antenna grounding.

Smart glasses such as augmented reality (AR) glasses require built-in antennas to receive signals such as Wifi and Bluetooth. Among them, coaxial line 300 feeding is a common feeding method for antennas. However, the electrical length of the longer coaxial line 300 is comparable to the working wavelength of the antenna. The shielding layer of the coaxial line 300 has a strong surface current distribution, which affects the impedance matching and consistency of the antenna. This solution electrically connects the shielding layer of the coaxial line 300 to the conductive support member 100. In this way, the support member 100 not only has its own supporting effect, but also can improve the surface current distribution of the shielding layer of the coaxial line 300, thereby improving the effect of the surface current on the impedance matching and consistency of the antenna, and improving the antenna performance. Therefore, this solution can save the additional grounding structure of the antenna, thereby reducing the space occupied by the antenna, improving the space utilization of the smart glasses, and thus improving the compactness of the smart glasses.

In an embodiment, the coaxial line 300 also has an outer insulating layer covering the shielding layer; when the coaxial line 300 is peeled off, a plurality of grounding positions are spaced apart along its length, exposing the shielding layer at the grounding positions for electrical connection with the support member 100. It is understood that collisions are inevitable during use or transportation, and collisions can easily cause the grounding positions to become electrically disconnected from the support member 100, that is, the shielding layer and the support member 100 to become electrically disconnected. In this solution, multiple grounding positions are provided on the coaxial line 300. Even if the electrical connection between a particular grounding position and the support member 100 is disconnected, the remaining grounding positions remain electrically connected to the support member 100. This ensures the stability of the electrical connection between the shielding layer and the support member 100, thereby improving antenna performance.

In this embodiment, the coaxial line 300 is provided with three grounding positions. The shielding layer of the coaxial line 300 is exposed at three positions, and each grounding position is electrically connected to three positions of the support member 100. In a second embodiment, the coaxial line 300 may also have two grounding positions. In a third embodiment, the coaxial line 300 may also have five grounding positions; the specific number of grounding positions of the coaxial line 300 is not limited herein.

In an embodiment, a protective layer is provided on the outer surface of the support member 100, and an electrical connection position 110 is provided on the support member 100 corresponding to each grounding position. The protective layer is removed at the electrical connection position 110 to electrically connect it to the shielding layer of the corresponding grounding position. It can be understood that by first removing the protective layer on the outer surface of the support member 100 and then electrically connecting the electrical connection position 110 to the shielding layer of the corresponding grounding position, the influence of the protective layer on the electrical connection can be avoided, thereby increasing the stability of the antenna grounding.

The electrical connection points 110 are configured as laser engraved points. In an embodiment, these points are where the protective layer on the outer surface of the support member 100 is removed through a laser engraving process. Laser engraving offers high precision, accurately removing the protective layer at fixed locations, thereby reducing machining errors and improving the fit between the electrical connection points 110 and the connection points. In an embodiment, the laser engraving process is cost-effective due to its high speed, one-step processing, and low energy consumption. In an embodiment, its high processing efficiency can improve the production efficiency of smart glasses.

The electrical connection position 110 is configured as a grinding position. In an embodiment, the grinding position refers to a position where a protective layer on the outer surface of the support member 100 is removed by a grinding process.

The protective layer may be a coating layer. When the support member 100 is a metal support member 100, the protective layer may also be an oxide layer.

In an embodiment, the electrical connection position 110 is electrically connected to the grounding position through a conductive adhesive 400. This is because, firstly, the conductive adhesive 400 has good conductivity and can effectively conduct current, which can improve the conductivity between the shielding layer and the support member 100. Secondly, the conductive adhesive 400 is easy to process and can be easily processed into various forms. When the conductive adhesive 400 is used to conduct the shielding layer and the support member 100, the conductive adhesive 400 can adapt to the gap between the shielding layer and the support member 100 and form a specific form, thereby reducing the operational difficulty of conduction between the shielding layer and the support member 100. Thirdly, the conductive adhesive 400 has a long service life and will not reduce its conductivity and adhesion over time. Therefore, using the conductive adhesive 400 to conduct the support member 100 and the shielding layer can not only ensure the stability of the grounding of the shielding layer, but also increase the stability of the connection between the support member 100 and the shielding layer. Fourthly, the conductive adhesive 400 also has excellent plasticity and scalability, and can be processed by coating, printing, spraying, and other processing methods on substrates of different shapes and sizes formed between the shielding layer and the support member 100, thereby reducing the difficulty of operation. Fifthly, the conductive adhesive 400 has excellent adhesion properties, and therefore, the conductive adhesive 400 can also increase the connection strength between the coaxial line 300 and the support member 100. Sixthly, the conductive adhesive 400 has high stability. During the preparation process, the conductive adhesive 400 can control its conductive performance and stability by adjusting parameters such as the composition of the colloidal matrix and the concentration of the conductive particles. In this way, it can be formulated according to the current intensity of the shielding layer of the coaxial line 300 of the smart glasses, which can better improve the impedance matching and consistency of the surface current on the antenna. Seventhly, the conductive adhesive 400 has a low cost, which can reduce the grounding cost of the smart glasses.

Among them, the conductive adhesive 400 can be silver powder conductive adhesive, carbon conductive adhesive, copper silver conductive adhesive, carbon nanotube conductive adhesive, silver paste conductive adhesive, conductive epoxy resin adhesive, nickel coating conductive adhesive or high viscosity conductive adhesive, etc., and no specific restrictions are made on the conductive adhesive 400 here.

In other embodiments, copper oxide paste may also be used to achieve grounding of the support member 100 and the shielding layer.

In an embodiment, the imaging device 200 includes an optical machine and a waveguide plate 210; the support member 100 includes a first support portion 120 for installing the waveguide plate 210, and a second support portion 130 for installing the optical machine, and the first support portion 120 and the second support portion 130 are both provided with an electrical connection position 110; this is because the side area of the second support portion 130 is larger, so that the area of the electrical connection position 110 on the second support portion 130 can be larger, so that more conductive adhesive 400 can be applied, so that the volume of the cured conductive adhesive 400 is larger, thereby making the conductive performance and fixing performance of the shielding layer and the support member 100 more stable.

In an embodiment, the outer insulating layer of the coaxial line 300 is bonded and fixed to the support member 100. This is because the bonding connection method is simple and can improve the connection efficiency between the coaxial line 300 and the insulating layer.

In an embodiment, the outer insulating layer of the coaxial line 300 is bonded to the support member 100 by means of the structural adhesive 500. This is because the structural adhesive 500 has high strength, which can improve the connection strength between the outer insulating layer of the coaxial line 300 and the support member 100, and reduce the probability of unstable connection between the outer insulating layer of the coaxial line 300 and the support member 100, thereby affecting the grounding effect between the support member 100 and the shielding layer. Secondly, the structural adhesive 500 has a short curing time, which can greatly improve the connection efficiency between the outer insulating layer of the coaxial line 300 and the support member 100, thereby improving the production efficiency of the smart glasses. In an embodiment, the structural adhesive 500 is waterproof and shockproof, making the smart glasses more durable. Of course, the present application is not limited to this. In other embodiments, the outer insulating layer of the coaxial line 300 can also be directly bonded to the support member 100 by means of the conductive adhesive 400.

In this solution, the coaxial line 300 is connected to the outer insulating layer and the support member 100 through the structural adhesive 500, and the shielding layer and the support member 100 are electrically connected through the conductive adhesive 400, so that the coaxial line 300 can be stably fixed and have an excellent grounding effect.

In an embodiment, the structural adhesive 500 is configured as UV adhesive (shadowless adhesive, photosensitive adhesive or ultraviolet light curing adhesive). This is because the UV adhesive can cure quickly, which can greatly improve the connection efficiency between the outer insulating layer of the coaxial cable 300 and the support member 100, thereby improving the production efficiency of the smart glasses. Secondly, the UV adhesive has strong adhesion, which can improve the connection strength between the outer insulating layer of the coaxial cable 300 and the support member 100, and reduce the probability of unstable connection between the outer insulating layer of the coaxial cable 300 and the support member 100, which affects the grounding effect between the support member 100 and the shielding layer. Moreover, the odor is small, which can reduce the odor of the smart glasses and improve the comfort of the user. In an embodiment, the reliability of the UV adhesive is high, which can improve the connection stability between the outer insulating layer of the coaxial cable 300 and the support member 100. Of course, the present application is not limited to this. In other embodiments, the structural adhesive 500 can also be configured as a polyurethane structural adhesive (PUR) or a polycarbonate structural adhesive (PC).

In an embodiment, the coaxial line 300 is provided with a plurality of bonding positions spaced apart along its length direction, and the plurality of bonding positions and the plurality of grounding positions are alternately arranged in sequence, which can increase the stability of the electrical connection between the grounding positions and the electrical connection positions 110.

In an embodiment, the support member 100 is the frame of the smart glasses or an independent component located in the frame. In an embodiment, the present solution achieves grounding through the frame of the smart glasses or an independent component located in the frame. This can save the additional grounding structure of the antenna, thereby reducing the space occupied by the antenna grounding structure, improving the space utilization of the frame, and further improving the compactness of the frame.

In this embodiment, the support member 100 is made of a conductive metal. This is because conductive metal not only has excellent electrical conductivity, but also possesses high strength and rigidity. This metal can improve current distribution on the surface of the shielding layer of the coaxial cable 300 while providing more stable support for the imaging device 200. Of course, the present application is not limited to this. In other embodiments, the support member 100 can also be made of a conductive non-metal, as long as it can achieve both electrical conductivity and support.

In an embodiment, the imaging device 200 includes two waveguides 210, and the support member 100 includes two first support portions 120 for mounting the two waveguides 210, respectively. Each waveguide 210 is provided with an antenna, and the coaxial lines 300 of the two antennas extend to the upper side of the same first support portion 120 and are fixed and electrically connected thereto. This reduces the number of electrical connection points on the support member 100, thereby improving the electrical connection efficiency between the coaxial lines 300 and the support member 100, and thereby increasing the production efficiency of the smart glasses.

The above descriptions are only some embodiments of the present application, and does not limit the patent scope of the present application. All equivalent structural transformations made by configuring the contents of the present application specification and drawings under the technical concept of the present application, or directly/indirectly applied in other related technical fields, are included in the patent protection scope of the present application.

What is claimed is:

1. Smart glasses, comprising:
a support member;
an imaging device mounted on the support member; and
an antenna comprising an antenna body and a coaxial line electrically connected to the antenna body, wherein the coaxial line is provided with a shielding layer;
wherein the support member is conductive, and the coaxial line is fixed to the support member; the shielding layer is electrically connected to the support member to achieve grounding of the antenna.

2. The smart glasses according to claim 1, wherein the coaxial line is further provided with an outer insulating layer covering the shielding layer, and the coaxial line is peeled to have a plurality of grounding positions spaced apart along a length direction of the coaxial line; the grounding positions expose the shielding layer for electrical connection with the support member.

3. The smart glasses according to claim 2, wherein a protective layer is provided on an outer surface of the support member, and the support member is provided with an electrical connection position corresponding to each of the grounding positions; the protective layer is removed at the electrical connection position to electrically connect to the shielding layer corresponding to the grounding position.

4. The smart glasses according to claim 3, wherein the electrical connection position is configured as a laser engraved position or a polished position.

5. The smart glasses according to claim 3, wherein the electrical connection position and the grounding position are electrically connected via a conductive adhesive.

6. The smart glasses according to claim 3, wherein the imaging device comprises an optical engine and a waveguide plate; the support member comprises a first support portion for mounting the waveguide plate, and a second support portion for mounting the optical engine, and the first support portion and the second support portion are both provided with the electrical connection position.

7. The smart glasses according to claim 2, wherein the outer insulating layer of the coaxial line is bonded and fixed to the support member.

8. The smart glasses according to claim 7, wherein the coaxial line is provided with a plurality of bonding positions spaced apart along the length direction of the coaxial line, and the plurality of bonding positions and the plurality of grounding positions are alternately arranged in sequence.

9. The smart glasses according to claim 1, wherein the support member is a frame of the smart glasses or an independent component located within the frame.

10. The smart glasses according to claim 1, wherein the imaging device comprises two waveguide plates, and the support member comprises two first support portions for mounting the two waveguide plates respectively; each of the waveguide plates is provided with the antenna, and the coaxial lines of the two antennas extend to an upper side of the same first support portion and are fixed and electrically connected to the first support portion.
